(19) United States
(12) Patent Application Publication
(10) Pub. No.: US 2025/0298604 A1
(43) Pub. Date: Sep. 25, 2025

(54) MANAGEMENT APPARATUS AND METHOD OF MANAGING FACILITY DEVICE

(71) Applicant: Mitsubishi Electric Corporation, Tokyo (JP)

(72) Inventors: Koki OMATA, Tokyo (JP); Saki MIYAI, Tokyo (JP); Kanta MIYAMOTO, Tokyo (JP); Taichi ISHIZAKA, Tokyo (JP)

(21) Appl. No.: 18/867,852

(22) PCT Filed: Jun. 16, 2022
(86) PCT No.: PCT/JP2022/024181

§ 371 Date: Nov. 21, 2024

(51) Int. Cl. G06F 8/65

(52) U.S. Cl. CPC G06F 8/65

(57) ABSTRACT

In a facility management system, a management apparatus stores a version of a control program stored in each of one or more facility devices. In response to arrival of a predetermined timing, for each of the one or more facility devices, the management apparatus determines whether or not it is necessary to update a control program, by comparing a version of a control program stored in the management apparatus with a version specified by version information of a control program stored in a cloud server. Then, the management apparatus downloads the control program from the cloud server for a facility device for which it has been determined that it is necessary to update the control program.

### TECHNICAL FIELD

The present disclosure relates to management of a facility device.

### BACKGROUND ART

In general, facility devices such as an air conditioning device and a lighting device are installed in a building such as a house, and a management apparatus for managing these devices is also installed. Through wired or wireless communication with such facility devices, the management apparatus monitors and controls these facility devices. As facility devices have been recently more advanced in function, programs also have tended to become complicated. Thus, in markets, there has been an increase in number of situations year by year in which programs of facility devices need to be updated on the scene due to program defects, security vulnerability, or the like.

Herein, as an example of such a facility device, regarding devices installed on a ceiling or a roof of each room inside a building such as an indoor unit and an outdoor unit of an air conditioning device, the following describes an operation procedure performed when it becomes necessary to update a program for such a facility device.

First, program update information (such as a target type name, a target version, an update destination version, update reasons, and the like) is posted on a homepage or the like of a facility device manufacturer. A facility management department in a building acquires program update information about a facility device, searches for the type name of the facility device installed in the building and the version of the currently operating program, checks on the homepage of the facility device manufacturer whether or not the version is a target to be updated, and determines whether or not it is necessary to update the program. When it is necessary to update the program, the facility management department in the building makes contact with the service company of the facility device to coordinate their schedules. A dispatched service operator visits the place (on a roof, above a ceiling, and the like) where the facility device is installed, and then, performs a program update operation. Since such a series of operations are required for updating the program of the facility device, it takes much time and cost in many cases.

Various studies have been conducted to solve such problems. For example, Japanese Patent Laying-Open No. 2010-205152 (PTL 1) discloses a network system and a network adapter that facilitate checking of the information about version upgrade of software (sub-software) executed by a sub-processing unit of the network adapter, and make it easy to determine the necessity of the version upgrade.

More specifically, in the system disclosed in PTL 1, when a version checking button is pressed on an operation terminal within its premises, a version upgrade checking request is transmitted to a center server. In response to the request, the center server receives the version information about the sub-software, and determines whether or not a version upgrade of the sub-software is necessary. Then, when the center server determines that the version upgrade is necessary, it transmits information about the version upgrade to the network. On the operation terminal, a web page included in a version upgrade checking response is displayed. When a user operates the operation terminal, a version upgrade start request is transmitted to the center server. Thereby, the center server receives the version upgrade start request. Then, the center server transmits, to a network adapter, version upgrade information used for upgrading to sub-software provided with the version information newer than the version information received from the network adapter. In the network adapter, when a main processing unit receives the version upgrade information and outputs the received information to a sub-processing unit, the sub-processing unit rewrites the sub-software stored in a sub-storage unit based on the version upgrade information.

### CITATION LIST

### Patent Literature

PTL 1: Japanese Patent Laying-Open No. 2010-205152

### SUMMARY OF INVENTION

### Technical Problem

By applying the technique disclosed in PTL 1, the version of the software of each facility device such as a network adapter is easily checked, and the necessity of version upgrade is easily determined. Further, when it is notified that the version upgrade of the software is necessary, the version upgrade information of the software is downloaded from a server, which facilitates rewriting into the latest version in the facility device.

However, even if the technique disclosed in PTL 1 is applied, a user's operation is still required for updating the software of the facility device. In other words, as described above, in the system disclosed in PTL 1, it is not until the timing at which the user presses the version checking button for the program on the operation terminal that a process of determining the necessity of an update is started. Therefore, even if the latest version of the program is posted that is executed for a defect correction or a function improvement for the facility device, the necessity of the program update in the facility device is not recognized unless the user who uses the latest version performs a version checking operation on the operation terminal. In view of such a situation, there is a demand for a technique for updating software of the facility device not only in a simple and easy manner but also in a manner in which the user's comfortability and security are reliably ensured.

The present invention has been made to solve the above-described problems, and an object thereof is to provide a technique for updating software of a facility device not only in a simple and easy manner but also in a manner in which user's comfortability and security are reliably ensured.

### Solution to Problem

The present disclosure relates to a management apparatus that manages one or more facility devices constituting a facility device group. The management apparatus includes: a storage device to store a version of a control program stored in each of the one or more facility devices; a communication interface to communicate with a server storing a control program of the facility device; and a controller to, in response to arrival of a predetermined timing, for each of the one or more facility devices, determine whether or not it is necessary to update the control program, by comparing the version of the control program stored in the storage device with a version specified by version information of the control program stored in the server. The controller is configured to download, from the server, the control program for a facility device for which it has been determined that it is necessary to update the control program.

According to another aspect of the present disclosure, a method of managing one or more facility devices by a management apparatus, the one or more facility devices constituting a facility device group. The method of managing one or more facility devices includes, in response to arrival of a predetermined timing, for each of the one or more facility devices, determining whether or not it is necessary to update a control program, by comparing a version of a control program stored in a storage device of the management apparatus with a version specified by version information of a control program stored in a server. The method of managing one or more facility devices further includes, for a facility device for which it has been determined that it is necessary to update the control program, downloading the control program from the server.

### Advantageous Effects of Invention

According to the present disclosure, in response to arrival of the predetermined timing, the management apparatus determines whether or not it is necessary to update the control program of the facility device. When the management apparatus determines that it is necessary to update the control program, it downloads a control program from the server. Thereby, the management apparatus downloads the latest control program from the server without requiring a user's operation. Therefore, the user does not perform a checking operation, which makes it possible to avoid a situation in which downloading of the latest control program is delayed and thereby the user's comfortability and security are not ensured.

### BRIEF DESCRIPTION OF DRAWINGS

FIG. 1 is a diagram showing a configuration of a facility management system 1 according to one embodiment of the present disclosure.

FIG. 2 is a block diagram showing a configuration of a management apparatus 3 in a first embodiment.

FIG. 3 is a block diagram showing a configuration of a cloud server 4 in the first embodiment.

FIG. 4 is a diagram showing a flow of an update program check process executed by management apparatus 3 and cloud server 4.

FIG. 5 is a diagram showing a flow of a program update necessity checking process executed by management apparatus 3 and cloud server 4.

FIG. 6 is a diagram showing a flow of an update program downloading process executed by management apparatus 3 and cloud server 4.

FIG. 7 is a diagram showing a flow of a program updating process executed by management apparatus 3.

FIG. 8 is a flowchart showing a modification of the program update necessity checking process in FIG. 5.

FIG. 9 is a block diagram showing a configuration of a management apparatus 3 in a second embodiment.

FIG. 10 is a diagram showing a flow of an update program check process executed by management apparatus 3 and a cloud server 4.

FIG. 11 is a diagram showing a flow of a program update necessity checking process executed by management apparatus 3 and cloud server 4.

FIG. 12 is a diagram showing a flow of a program downloading process executed by management apparatus 3 and cloud server 4.

FIG. 13 is a diagram showing a flow of a program updating process executed by management apparatus 3.

### DESCRIPTION OF EMBODIMENTS

Hereinafter, embodiments of the present disclosure will be described in detail with reference to the accompanying drawings. While a plurality of embodiments will be hereinafter described, it has been originally intended to combine the configurations described in each embodiment as appropriate. In the accompanying drawings, the same or corresponding portions are denoted by the same reference characters, and the description thereof will not be repeated.

### First Embodiment.

### Facility Management System

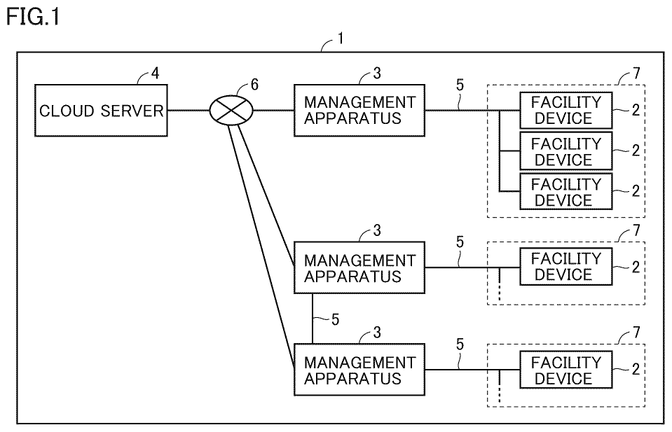

FIG. 1 is a diagram showing a configuration of a facility management system 1 according to one embodiment of the present disclosure. As shown in FIG. 1, facility management system 1 includes a facility device 2, a management apparatus 3, and a cloud server 4. In facility management system 1, a plurality of facility devices 2 and a plurality of management apparatuses 3 are provided.

Facility device 2 and management apparatus 3 are connected to each other through a dedicated communication line 5. Thereby, facility device 2 and management apparatus 3 can communicate with each other. The plurality of management apparatuses 3 may be communicably connected to each other through dedicated communication line 5.

Management apparatus 3 and cloud server 4 are connected to each other through a communication line 6. Thereby, management apparatus 3 can communicate with cloud server 4. Communication line 6 may be, for example, an Internet line that connects cloud server 4 and management apparatus 3 through a broadband router. Communication line 6 may also be configured as a local area network (LAN) in which management apparatus 3 and cloud server 4 are connected within an identical location.

Examples of facility device 2 include various facility devices installed inside a building. More specifically, facility device 2 is, for example, an air-conditioning device, a lighting device, or a water heater.

A plurality of facility devices 2 are installed at designated locations inside the building. Each facility device 2 operates under the management of management apparatus 3. Management apparatus 3 is notified of the operation state of facility device 2 through dedicated communication line 5. The plurality of facility devices 2 connected to the same management apparatus 3 are also hereinafter referred to as a “facility device group 7”.

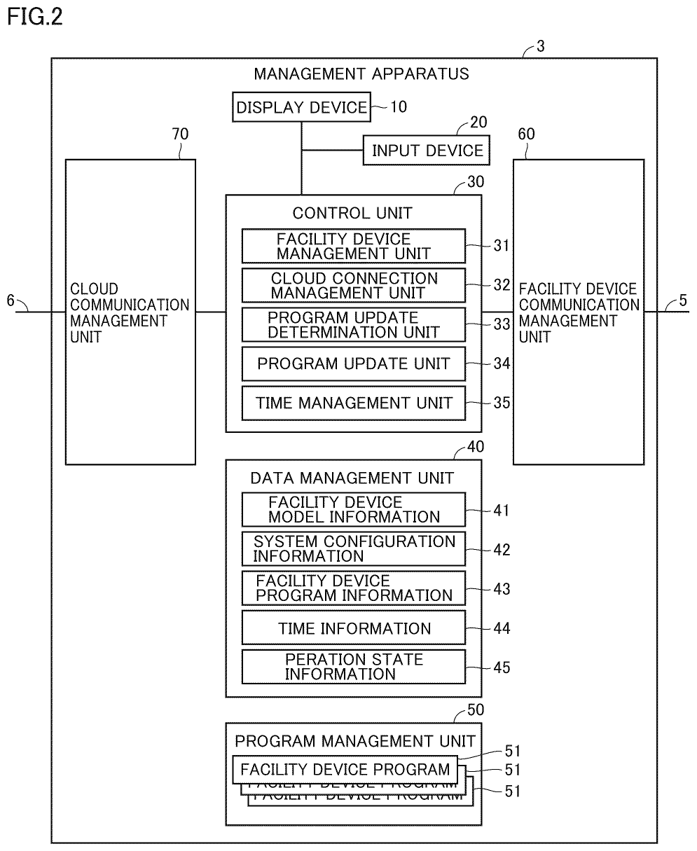

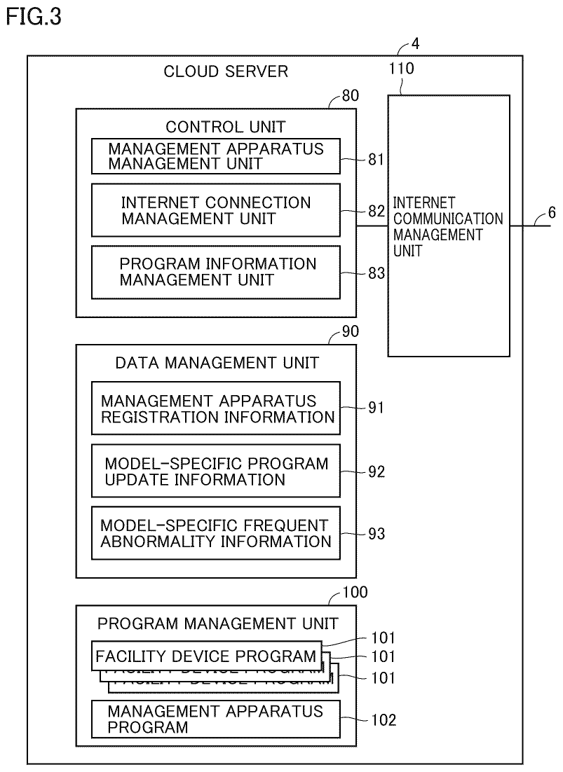

Management apparatus 3 comprehensively manages facility device group 7 including the plurality of facility devices 2. Cloud server 4 is a general-purpose computer that is connected to the Internet and performs its operation. Cloud server 4 stores: program update information about each facility device (information that is referred to for a program update and that specifies the latest version); and registration information of management apparatus 3. The following describes the configuration of management apparatus 3 with reference to FIG. 2, and the configuration of cloud server 4 with reference to FIG. 3.

### Management Apparatus

FIG. 2 is a block diagram showing a configuration of management apparatus 3 in the first embodiment. As shown in FIG. 2, management apparatus 3 includes a display device 10, an input device 20, a control unit 30, a data management unit 40, a program management unit 50, a facility device communication management unit 60, and a cloud communication management unit 70.

Under the control of control unit 30, display device 10 displays various types of screens on which facility device group 7 is managed (monitored and controlled) and a notice is given to a user.

Input device 20 is an input device such as a mouse, a keyboard, and/or a touch panel. When input device 20 is a touch panel, input device 20 is installed on display device 10. By operating input device 20, an administrator can implement various types of controls such as switching of screens or an operation of the facility device.

Control unit 30 is a computer including a central processing unit (CPU), a memory, and the like. In one implementation, the CPU executes a program stored in the memory to implement the function of control unit 30. Control unit 30 is an example of a controller that controls management apparatus 3.

Control unit 30 maintains (manages) the operation state of facility device 2, and performs a process of transmitting and receiving data to and from cloud server 4, the date being required for a monitor screen to be displayed.

Control unit 30 includes, as its functions, a facility device management unit 31, a cloud connection management unit 32, a program update determination unit 33, a program update unit 34, and a time management unit 35.

Facility device management unit 31 manages (monitors and controls) the operation state of facility device 2. In one implementation, at regular time intervals, facility device management unit 31 collects, from each facility device 2, the operation state of facility device 2 and the version information of the control program stored (installed) in facility device 2. When facility device 2 is an air conditioning device, the operation state is, for example, an operated/stopped state, an operation mode such as cooling or heating, a set temperature, an indoor temperature, and/or an operation schedule. In the present specification, the “control program” may also be simply referred to as a “program”.

Cloud connection management unit 32 communicates with cloud server 4. Specifically, at a predetermined timing, cloud connection management unit 32 acquires the program update information of facility device 2 managed by management apparatus 3 (management apparatus 3 including this cloud connection management unit 32) from cloud server 4. The predetermined timing may occur at regular time intervals, or may occur at one or more timings (for example, 5:00 a.m. and 11:30 a.m. on each day) scheduled in advance by the administrator or the like.

Further, cloud connection management unit 32 receives the update program of facility device 2 from cloud server 4, and stores the received update program as a facility device program 51 in program management unit 50.

Based on the program update information received from cloud server 4, program update determination unit 33 determines whether or not it is necessary to update the program in facility device 2 managed by management apparatus 3. Specifically, it is determined whether or not it is necessary to update the program in facility device 2 by comparing the version of the control program stored in facility device 2 with the version of the control program of facility device 2 specified in the program update information downloaded from cloud server 4. The control program of facility device 2 is a program executed to control facility device 2. The program update information may include information representing a defect corrected in the latest program of each facility device and/or information about an added function. Program update determination unit 33 may determine that it is necessary to update the program in facility device 2 on the condition that the information included in the program update information includes a corrected defect or an added function.

In one example, when the version of the program stored in facility device 2 is older than the version of the program downloaded from cloud server 4, program update determination unit 33 determines that it is necessary to update the program in facility device 2. When the version of the program stored in facility device 2 is the same as the version of the program downloaded from cloud server 4 or is newer than the version of the program downloaded from cloud server 4, it is determined that it is not necessary to update the program in facility device 2. Even when it is determined based on the version or the like that it is necessary to update the program, but if the program downloaded from cloud server 4 is not suitable for the program update setting that has been set in advance, program update determination unit 33 may determine that it is not necessary to update the program.

The information specifying the timing at which program update determination unit 33 determines the necessity of an update of the program is stored as “check time” in a storage device of management apparatus 3. In other words, the necessity of an update of the program is determined at a predetermined timing. The “check time” is a component of time information 44, which will be described later. The check time may be set by the user or may be set by the administrator of facility management system 1. In facility device group 7, the check time may be set for each facility device 2 or may be the same for all facility devices 2.

When program update determination unit 33 determines that it is necessary to update the program, it downloads the update program of facility device 2 from cloud server 4.

Program update unit 34 updates the program. Specifically, program update unit 34 updates the program of facility device 2 through dedicated communication line 5.

When it is determined that it is necessary to update the program in facility device 2, program update unit 34 may update the program of facility device 2 without requiring the user's operation. When it is determined that it is necessary to update the program in facility device 2, program update determination unit 33 may cause display device 10 to display a setting screen of the update time of the program, and update the program of facility device 2 in response to an operation performed on input device 20 by the user (at a timing set by the user).

Program update determination unit 33 may cause display device 10 to display a setting screen of the time at which the program is updated. When displaying the setting screen, program update determination unit 33 may calculate a candidate for the update time of the program based on facility device model information 41 and/or operation state information 45, and present the candidate on the setting screen. The number of candidates may be one or may be more than one. When the program update information includes information indicating a defect corrected in the latest program of each facility device and/or information about an added function, program update determination unit 33 may cause the setting screen to display the information indicating the defect and/or the added function.

One example of the calculated candidate is time included in a time zone in which facility device 2 is scheduled to be not operated (to be stopped), in the operation schedule included in operation state information 45. For example, when the operation schedule specifies that facility device 2 is stopped from 1 a.m. to 4 a.m., one example of the calculated candidate may be time included in the time zone (from 1 a.m. to 4 a.m.). More specifically, program update determination unit 33 may calculate the time after an elapse of a certain time period (for example, 5 minutes) from the start of this time zone as a candidate for the update time of the program. Another example of the calculated candidate may be the time obtained in consideration of the time required for an update, regarding the target update program specified from the model name, the type name, and/or the manufacturing number included in facility device model information 41. Examples of the time zone that may be excluded from the candidates is a time zone in which it is assumed that the update does not end by the time when facility device 2 starts the operation in the operation schedule. For example, when the operation schedule specifies that facility device 2 stops its operation from 1 a.m. to 4 a.m. and resumes its operation from 4 a.m., and when the time period required for a program update is calculated as 20 minutes based on the data size of the update program, then, the time zone after 3:40 a.m. (20 minutes before 4 a.m.) may be excluded from the candidates. More specifically, even when the candidates for the update time of the program are primarily calculated as “3:00 a.m.”, “3:15 a.m.”, “3:30 a.m.”, and “3:45 a.m.”, this “3:45 a.m.” may be excluded, and “3:00 a.m.”, “3:15 a.m.”, and “3:30 a.m.” may be finally presented as candidates. Further, the candidate may represent the update start time or may represent a time zone that can be designated as the start time. In other words, the candidate may represent one or more times (for example, “3:00 a.m.”, “3:15 a.m.”, and “3:30 a.m.”) or may represent one or more time zones (for example, “3:00 a.m. to 3:30 a.m.”).

When program update determination unit 33 causes display device 10 to display the setting screen of the update time of the program, it may causes display device 10 to display the update time of the previous program of facility device 2 based on facility device program information 43. When there is no information to be displayed, program update determination unit 33 may display that such information cannot be displayed.

Time management unit 35 manages time information (check time, program

update time, and the like). Specifically, time management unit 35 updates the time information, causes display device 10 to display a screen for updating the time information, and receives the setting of the time information (the check time and/or the program update time) from the user. Further, time management unit 35 detects that the check time or the program update time has arrived.

In one implementation, data management unit 40 and program management unit 50 each are implemented by a nonvolatile storage device. Data management unit 40 stores facility device model information 41, system configuration information 42, facility device program information 43, time information 44, and operation state information 45.

Facility device model information 41 includes information (a model name, a type name, a manufacturing number, and the like) about each facility device 2.

System configuration information 42 represents system configuration information about facility device group 7. The system configuration information includes, for example, an installation location, an address, a program update setting of each facility device 2, and a mode of connection to another management apparatus 3. The program update setting may define a condition related to the update of the program of each facility device 2. For example, the program update setting may specify that it is necessary to update the program only when a defect has been corrected for improvement by the program for an update or only when a new function has been added to the program for an update.

Facility device program information 43 represents program information of facility device 2. The program information includes, for example, the version of the latest program of each facility device 2 and the update time of the previous program.

Time information 44 includes, for example, check time and update time of a program for facility device 2.

Operation state information 45 includes various pieces of data required for control unit 30 to monitor facility device group 7 and various pieces of data for displaying a monitor screen to the user. Operation state information 45 includes, for example, setting data and operation information for each facility device 2. The setting data includes, for example, an operation schedule, program update time, and time at which information is transmitted to cloud server 4. When facility device 2 is an air conditioning device, the operation information includes, for example, an operated/stopped state, an operation mode such as cooling and heating, a set temperature, an indoor temperature, and abnormality information.

Program management unit 50 includes a plurality of facility device programs 51.

Facility device program 51 is, for example, a control program for facility device 2. Specifically, facility device program 51 includes a program that is downloaded from cloud server 4 and written onto each facility device 2 of facility device group 7.

Facility device communication management unit 60 serves as a communication interface for communication through dedicated communication line 5. Management apparatus 3 transmits and receives data to and from facility device 2 through facility device communication management unit 60. Dedicated communication line 5 does not necessarily have to be a dedicated communication line, but may be a general-purpose communication line such as a LAN or an RS-485 interface.

Cloud communication management unit 70 serves as a communication interface for communication through communication line 6. Management apparatus 3 transmits and receives data to and from cloud server 4 through cloud communication management unit 70. Communication line 6 may be a wired LAN or a wireless LAN. Communication line 6 may also be a line utilizing an Internet line or the like that connects cloud server 4 and management apparatus 3 via a broadband router.

### Cloud Server

FIG. 3 is a block diagram showing a configuration of cloud server 4 in the first embodiment. As shown in FIG. 3, cloud server 4 includes a control unit 80, a data management unit 90, a program management unit 100, and an Internet communication management unit 110.

In one implementation, control unit 80 is implemented by a processor such as a CPU executing a given program. Control unit 80 includes, as its functions, a management apparatus management unit 81, an Internet connection management unit 82, and a program information management unit 83.

Management apparatus management unit 81 manages management apparatus 3. Specifically, management apparatus management unit 81 manages, for example, processes of connection authentication and communication response for management apparatus 3.

Through communication with management apparatus 3 registered in management apparatus registration information 91, Internet connection management unit 82 transmits model-specific program update information 92 and each version of the program of facility device 2 to management apparatus 3.

Program information management unit 83 manages program information in management apparatus 3. Specifically, program information management unit 83 instructs, for example, each management apparatus 3 to add or delete a program stored in program management unit 50. Further, program information management unit 83 updates the model-specific program update information. In one implementation, the model-specific program update information (the information specifying a program to be stored by an update for each model corresponding to each facility device 2) represents the latest version of a facility device program 101 stored in program management unit 100, which will be described later.

In one implementation, data management unit 90 and program management unit 100 each are implemented by a nonvolatile storage device. Data management unit 90 stores management apparatus registration information 91, model-specific program update information 92, and model-specific frequent abnormality information 93.

Management apparatus registration information 91 includes information (for example, a client ID that permits connection, client certificate information, and the like) of management apparatus 3 registered in cloud server 4. Management apparatus 3 may be registered in cloud server 4 at the time of manufacturing a product of management apparatus 3 or after shipment of a product of management apparatus 3.

Model-specific program update information 92 includes program update information by each model. Specifically, the program update information by each model includes, for facility device 2: program information by each model (the latest version, function improvement information (whether or not a defect has been corrected, a function for which a defect has been corrected, details of the corrected defect, whether or not a new function has been added, details of the added function, and the like), device number of facility device 2 as a program update target, and the like); and/or defect information for each version and the like. The program update information by each model also includes information specifying the version of the program stored in program management unit 100. The program update information by each model further includes information defining the version of the latest program for management apparatus 3.

Model-specific frequent abnormality information 93 includes information about a function to be improved that has been extracted from the management apparatus registration information.

Program management unit 100 includes facility device program 101 and a management apparatus program 102.

Facility device program 101 is a control program of facility device 2. Program management unit 100 may store, as facility device program 101, programs of all versions for each model or a program of a version to be installed in facility device 2 at the present time.

Management apparatus program 102 is a control program of management apparatus 3. Program management unit 100 may store, as management apparatus program 102, programs of all versions or only a program of a version to be installed in management apparatus 3 at the present time.

Internet communication management unit 110 serves as an interface of communication line 6. Cloud server 4 transmits and receives data to and from management apparatus 3 through Internet communication management unit 110.

### Operation during Program Update

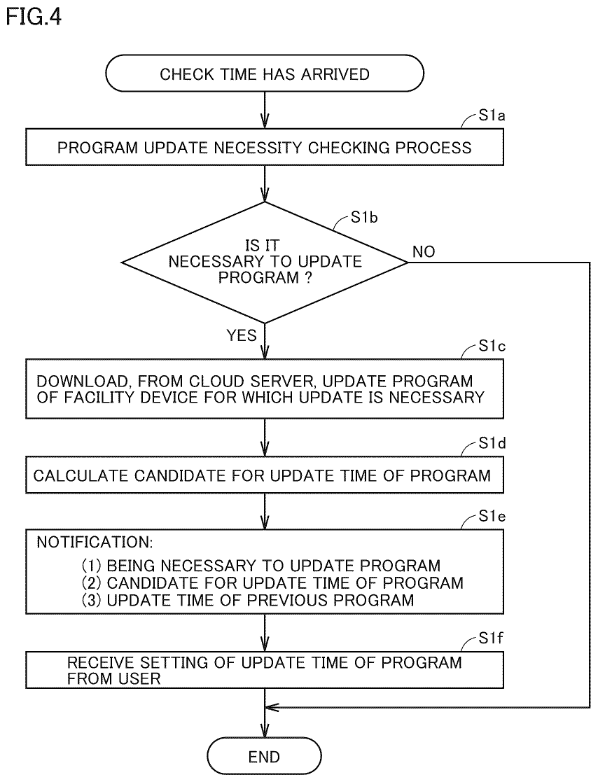

The following describes operations of management apparatus 3 and cloud server 4 related to an update of the program in facility device 2 with reference to FIGS. 4 to 7.

### Update Program Check

FIG. 4 is a diagram showing a flow of an update program check process executed by management apparatus 3 and cloud server 4.

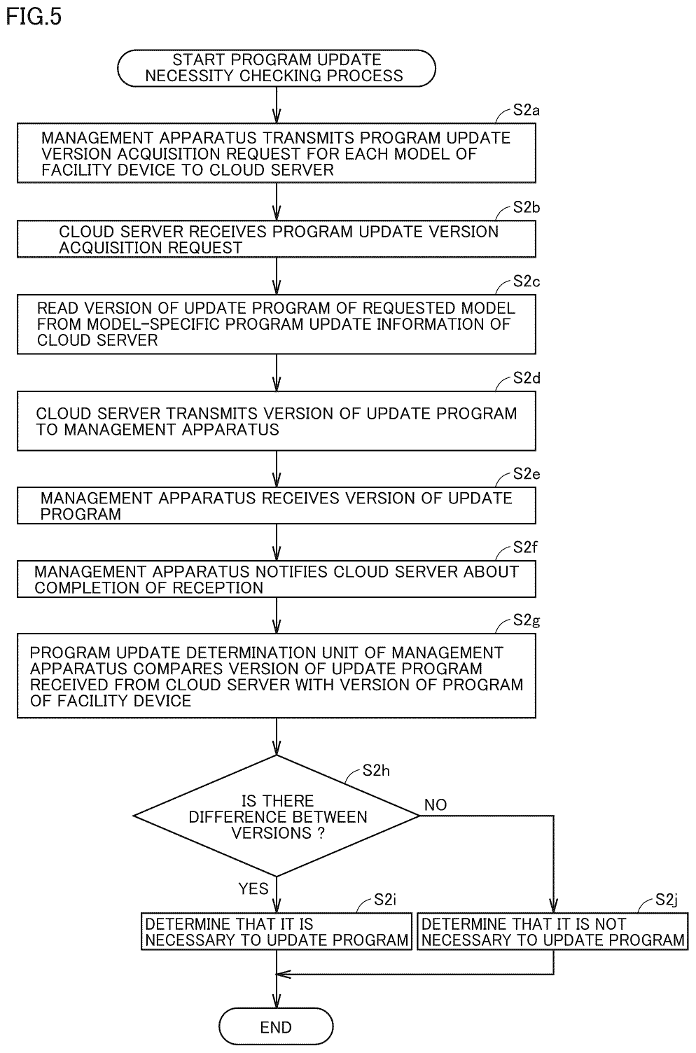

When time management unit 35 determines that the check time has arrived, cloud connection management unit 32 performs a program update necessity checking process (step S1a). In the program update necessity checking process, cloud connection management unit 32 transmits facility device model information 41, system configuration information 42, facility device program information 43, and operation state information 45 to cloud server 4 through cloud communication management unit 70. More specific details of the program update necessity checking process will be described later with reference to FIG. 5.

The process is branched according to the result of the determination in the program update necessity checking process (whether or not it is necessary to update the program in facility device 2) (step S1b). When it is determined that it is not necessary to update the program in facility device 2 (step S1b: No), program update determination unit 33 ends the process in FIG. 4.

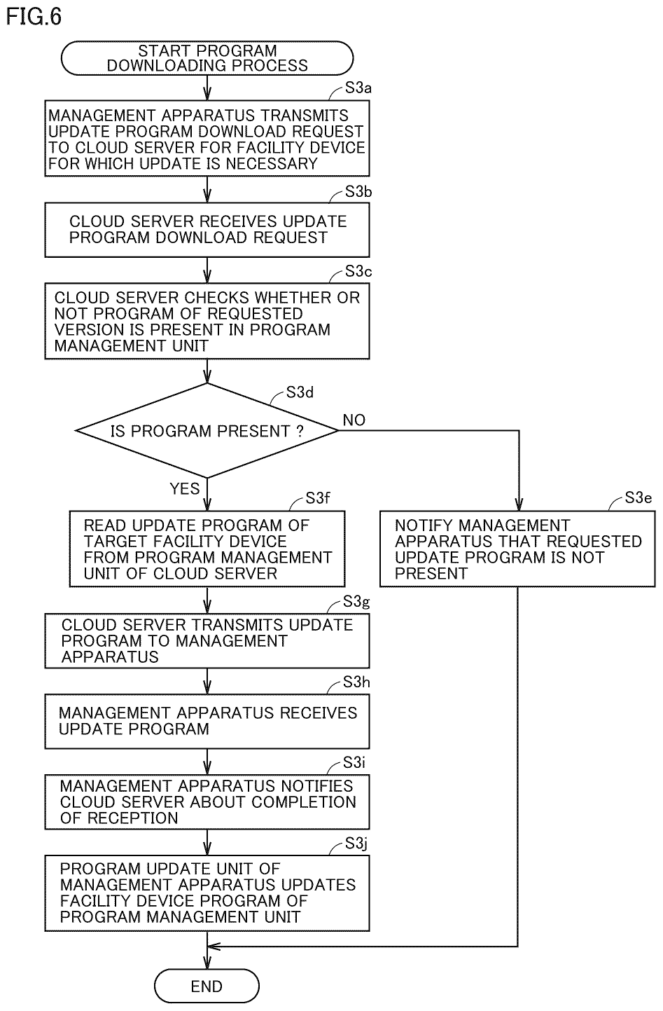

When it is determined that it is necessary to update the program in facility device 2 (step S1b: Yes), management apparatus 3 downloads, from cloud server 4, the update program of facility device 2 for which it has been determined that an update is necessary (step S1c). In the program update necessity checking process, the necessity of an update is determined for each of one or more facility devices 2. In step S1c, the update program is downloaded for each of all facility devices 2 for which it has been determined that an update is necessary. The details of the process for downloading the program in step S1c will be described later with reference to FIG. 6.

Subsequently, program update determination unit 33 calculates a candidate for the update time of the program (step S1d). In one implementation, the candidate for the update time is calculated based on facility device model information 41 and/or operation state information 45. When there is more than one facility device 2 for which it has been determined that it is necessary to update the program, then in step S1d, a candidate for the update time is calculated for each facility device 2.

Then, program update determination unit 33 notifies the user about the following three points (step S1e). When there is more than one facility device 2 for which it has been determined that it is necessary to update the program, then in step S1e, a notification is issued for each facility device 2.
Being necessary to update a program
A candidate for update time of a program
Update time of a previous program

The notification may be implemented by displaying the above-described information on display device 10, may be implemented by a notice given to the user, or may be implemented by both. The user is notified, for example, by program update determination unit 33 transmitting the above-mentioned information to a transmission destination (for example, an e-mail address of the user) associated with the user. In this case, for each facility device 2, a transmission destination (for example, an e-mail address of the user) associated with the user is stored in the storage device of management apparatus 3.

Subsequently, program update determination unit 33 causes display device 10 to display a setting screen of the update time of the program in facility device 2, and receives the setting of the update time of the program from the user (step S1f). Then, program update determination unit 33 ends the process in FIG. 4. In step S1f, program update determination unit 33 may cause the setting screen to display the information about the corrected defect and/or the information about the added function, each information being included in the program update information.

In the process described above with reference to FIG. 4, when a predetermined timing (check time) has arrived, management apparatus 3 determines whether or not it is necessary to update the control program for each of facility devices 2 constituting facility device group 7. When it is determined that it is necessary to update the control program of facility device 2, management apparatus 3 notifies about a candidate for the update time and receives the setting of the update time from the user. Note that management apparatus 3 may set the update time without requiring setting by the user. In one implementation, management apparatus 3 sets, as the update time, the time calculated as a candidate for the update time.

### Program Update Necessity Checking

FIG. 5 is a diagram showing a flow of a program update necessity checking process executed by management apparatus 3 and cloud server 4.

When the program update necessity checking process (step S1a in FIG. 4) is started, cloud connection management unit 32 of management apparatus 3 transmits a program update version acquisition request for each model of facility device 2 to cloud server 4 through cloud communication management unit 70 (Step S2a).

Then, Internet connection management unit 82 of cloud server 4 receives the program update version acquisition request (step S2b).

Subsequently, from model-specific program update information 92, program information management unit 83 reads the version and the function improvement information of the update program about the model requested in the program update version acquisition request (step S2c). In model-specific program update information 92, the version of the update program is stored as the version of the latest program by each model.

Then, cloud server 4 transmits the version of the update program of the requested model to management apparatus 3 through Internet connection management unit 82 and Internet communication management unit 110 (step S2d). The update program transmitted from cloud server 4 to management apparatus 3 is an update program determined as being appropriate to be transmitted to management apparatus 3 based on: the information kept by cloud server 4 (information such as a model and a version of the program of facility device 2 managed by management apparatus 3); and the information having been transmitted from management apparatus 3 (equipment device model information 41, system configuration information 42, and facility device program information 43). In this case, depending on the situation (the type of facility device 2 managed by management apparatus 3, the type of another device installed at the installation location of facility device 2 managed by management apparatus 3, and the like), the update program to be transmitted may not be the latest version.

Then, upon receipt of the version of the update program (step S2e), management apparatus 3 transmits a reception completion notification to the cloud server (step S2f).

Then, program update determination unit 33 compares, for each model, the version received from cloud server 4 with the version of the program collected from facility device 2 (step S2g).

Then, when there is a difference between the two versions compared in step S2g, program update determination unit 33 determines that it is necessary to update the program in facility device 2 (step S2h: Yes, and step S2i). Even when there is a difference between the above-mentioned two versions, but if it is not appropriate for the program update setting, program update determination unit 33 may determine that it is not necessary to update the program. On the other hand, when there is no difference between the versions of the programs, program update determination unit 33 determines that it is not necessary to update the program in facility device 2 (step S2h: No, and step S2j), and ends the process in FIG. 5.

When facility device group 7 includes a plurality of models of facility devices 2, then in step S2a, a program update version acquisition request is transmitted for each of the plurality of models. In this case, in step S2d, a version is transmitted for each of the plurality of models. Then, in step S2g, program update determination unit 33 compares, for each model, the version of the program collected from facility device 2 with the version received from cloud server 4, and in step S2h, determines whether or not it is necessary to update the program for each model.

### Download of Update Program

FIG. 6 is a diagram showing a flow of an update program downloading process executed by management apparatus 3 and cloud server 4.

When the program downloading process (step S1c in FIG. 4) is started, cloud connection management unit 32 of management apparatus 3 transmits an update program download request to cloud server 4 through cloud communication management unit 70 for facility device 2 for which it is necessary to update the program (step S3a).

Then, Internet connection management unit 82 of cloud server 4 receives the update program download request (step S3b).

Then, based on model-specific program update information 92, cloud server 4 checks whether or not the requested version of facility device program 101 is present in program management unit 100 (step S3c).

Then, when the requested version of facility device program 101 is not present (step S3d: No), cloud server 4 notifies management apparatus 3 through Internet connection management unit 82 and Internet communication management unit 110 that the requested version of the program is not present (step S3e), and then, ends the process in FIG. 6.

Then, when the requested version of facility device program 101 is present in program management unit 100 (step S3d: Yes), program information management unit 83 reads the requested facility device program 101 as an update program from program management unit 100 (step S3f).

Then, cloud server 4 transmits the program (update program) read in step S3f to management apparatus 3 through Internet connection management unit 82 and Internet communication management unit 110 (step S3g).

Then, upon receipt of the update program (step S3h), management apparatus 3 transmits a reception completion notification to cloud server 4 (step S3i).

Then, program update unit 34 uses the program received in step S3h to update facility device program 51 of program management unit 50 (step S3j), and ends the process in FIG. 6.

### Program Update

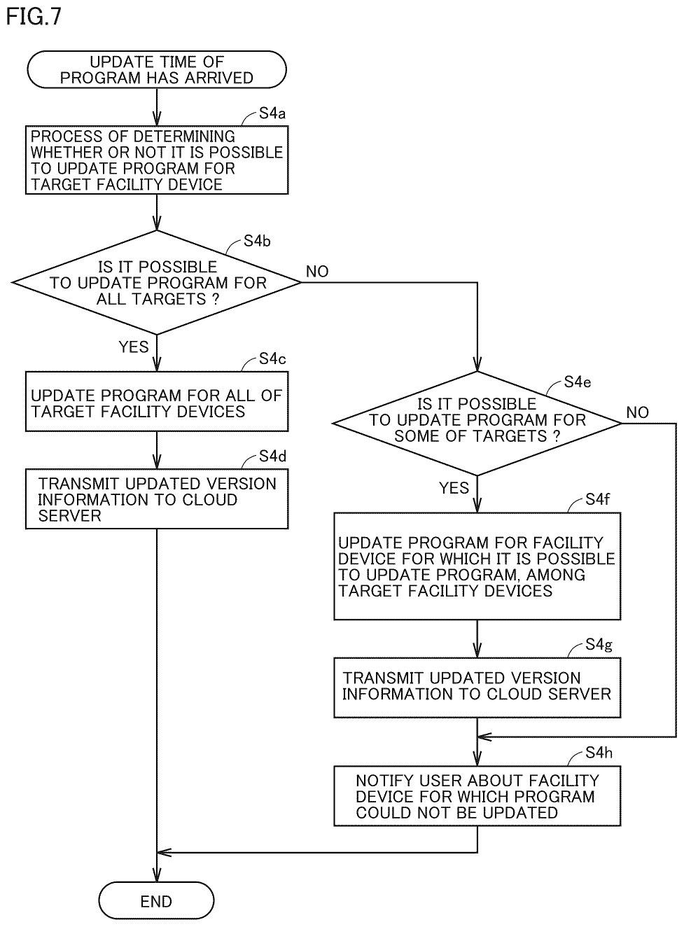

FIG. 7 is a diagram showing a flow of a program updating process executed by management apparatus 3.

When time management unit 35 detects that the program update time has arrived, program update determination unit 33 determines, based on the operation states of facility devices 2 collected by facility device management unit 31, whether or not it is possible to update the program for each of facility devices 2 each requiring a program update (step S4a). When facility device 2 is an air conditioning device, the operation state is, for example, an operated/stopped state, an operation mode such as cooling or heating, a set temperature, an indoor temperature, and/or an operation schedule.

In one implementation, the criterion of the determination in step S4a may be stored in the storage device of management apparatus 3 as setting data of the program for implementing program update determination unit 33.

One example of the criterion defines that, when the facility device is in operation, or when the start time of the operation schedule of the facility device is within 5 minutes, it is determined that it is not possible to update the program for this facility device.

Another example of the criterion defines that, even when an air conditioning device provided as a facility device is in operation, but if the indoor temperature in the space to be adjusted by the air conditioning device has reached the set temperature, it is determined that it is possible to update the program. In one implementation, in the case where the operation mode is a cooling mode and the set temperature is 28° C., and if the room temperature is 28° C. or lower, then, it is determined that the set temperature has been reached. Further, in the case where the operation mode is a heating mode and the set temperature is 18° C., and if the indoor temperature is 18° C. or higher, then, it is determined that the set temperature has been reached.

Then, program update determination unit 33 determines whether or not it is possible to update the program for all of facility devices 2 each requiring a program update (step S4b).

When it is possible to update the program for all of facility devices 2 each requiring a program update (step S4b: Yes), program update unit 34 updates the program for each of all facility devices 2 each requiring a program update with the use of an update program appropriate for each model (step S4c).

Then, program update unit 34 transmits the updated version information to cloud server 4 (step S4d). The updated version information indicates the version of the program installed after the update about facility device 2 for which the program has been updated. Thereby, cloud server 4 manages, as model-specific program update information 92, the version of the latest control program of each model, and as to which version of the program is installed in each facility device 2. Then, program update unit 34 ends the process in FIG. 7.

On the other hand, when it is not possible to update the program for all of facility devices 2 each requiring a program update (step S4b: No), program update unit 34 checks whether or not there is facility device 2 for which it is possible to update the program (step S4e).

When there is facility device 2 for which it is possible to update the program (step S4e: Yes), program update unit 34 updates the program for target facility device 2 for which it is possible to update the program, among facility devices 2 each requiring a program update (step S4f).

Then, program update unit 34 transmits, to cloud server 4, the version information after the update about facility device 2 for which the program has been updated (step S4g).

Then, program update unit 34 notifies the user about facility device 2 for which no update could be made (step S4h), and ends the process in FIG. 7. In this case, program update unit 34 may urge the user to again set the update time of the control program. When program update unit 34 receives the setting of the update time from the user, it updates the control program according to the newly received update time.

When there is no facility device 2 for which it is possible to update the program (step S4e: No), program update unit 34 notifies the user about facility device 2 for which the program could not be updated (step S4h), and ends the process in FIG. 7. The notification is implemented, for example, by a display on display device 10 and/or a notice given to the user. In step S4h, program update unit 34 may urge the user to again set the update time of the program. When program update unit 34 receives the setting of the update time from the user, it starts the process in FIG. 7 in response to arrival of the newly received update time.

In the process described with reference to FIG. 7, in response to execution of the program update of facility device 2 (step S4c or S4f), facility device management unit 31 may register the time at which the update was executed, as the “update time of the previous program”, in facility device program information 43 for facility device 2 to be updated.

### Summary of the Embodiment

In the above description, management apparatus 3 determines whether or not it is necessary to update the control program of facility device 2. Note that cloud server 4 may determine whether or not it is necessary to update the control program of facility device 2. In other words, cloud server 4 may determine whether or not the update is necessary, and management apparatus 3 may perform the update.

In the above description, management apparatus 3 downloads only the control program for which an update is necessary. Management apparatus 3 may download, in advance, one or more programs other than the programs for which an update is necessary, among the control programs stored in cloud server 4.

In the above description, management apparatus 3 transmits the reception completion notification to cloud server 4 when the reception of the program is completed. Note that management apparatus 3 may continue the process without transmitting the reception completion notification.

In the above description, the update time of the program is set by the user in step S1f and the like. The update time of the program does not necessarily have to be set by the user, and, for example, the time set in advance by the administrator may be utilized as the update time of the program. Further, management apparatus 3 may receive the setting of the update time of the control program of facility device 2 from the user at any timing other than the check time.

In the above description, when downloading the program, management apparatus 3 downloads the program for each model of facility device 2, and the same program is not downloaded a plurality of times in one downloading process. Note that management apparatus 3 may download a program for each facility device 2, and thus, the same program may be downloaded a plurality of times.

In the above description, management apparatus 3 downloads the update program from cloud server 4. When a program of a version scheduled to be downloaded has already been stored in another management apparatus 3 connected through dedicated communication line 5, management apparatus 3 may share the program with another management apparatus 3 through dedicated communication line 5. More specifically, in step S1c, management apparatus 3 may download the update program from another management apparatus 3 instead of downloading the update program from cloud server 4. At this time, management apparatus 3 may transmit an inquiry to another management apparatus 3 in facility management system 1 as to whether or not the update program is stored. In response to reception of the response from another management apparatus 3 that the update program is stored, management apparatus 3 may download the update program from this another management apparatus 3. When management apparatus 3 downloads an update program not from cloud server 4 but from another management apparatus 3, for example, the following effects are conceivable. In other words, in facility management system 1, when a cost is charged for the communication between management apparatus 3 and cloud server 4 according to the amount of communication, but no cost is charged for the communication between management apparatuses 3 according to the amount of communication, then, the cost occurring in this case can be reduced by a download from another management apparatus 3. In this respect, another management apparatus 3 is an example of an “information processing apparatus other than a server”.

In the above description, display device 10 and input device 20 included in management apparatus 3 are used for a notification given to the user and an input received from the user. When management apparatus 3 does not include a liquid crystal screen (display device 10 and input device 20) and is monitored and operated through a web browser of a general-purpose computer connected to management apparatus 3 via a LAN, it is intended to utilize a display device and an input device of this general-purpose computer for a notification given to the user and an input received from the user in the above description.

Although not particularly mentioned in the above description, an application program for monitoring and operation through a web browser may be installed in control unit 30 of management apparatus 3 for monitoring and operation using the above-mentioned general-purpose computer.

According to facility management system 1 in the above description, management apparatus 3 automatically (without requiring an instruction from the user) acquires an update program of facility device 2 from cloud server 4. Thereby, a user's periodic operation performed to check the update information is not required for acquiring an update program. Further, since management apparatus 3 determines whether or not it is necessary to update the program in facility device 2, the latest program can always be applied to the facility device without requiring service from a service company.

According to facility management system 1 in the above description, the user is notified that it is necessary to update the program in facility device 2. This prevents occurrence of a situation in which the user continues to use facility device 2 without knowing the presence of the update program.

According to facility management system 1 in the above description, it is possible to update the program in facility device 2 at a timing at which the user's comfortability is not impaired.

According to facility management system 1 in the above description, it is not necessary for a worker to visit the site for updating the program in facility device 2, so that the load for updating the program can be reduced.

According to facility management system 1 in the above description, candidates for the update time of the program are presented, so that the load applied to the user for determining the update time of the program in facility device 2 can be reduced.

According to facility management system 1 in the above description, it is possible to prevent the function of facility device 2 from being stopped due to the start of the program update during the operation of facility device 2.

In facility management system 1 in the above description, the notification about information is implemented by display, but may be implemented by other methods such as an output of sound. The information is input by an operation on a keyboard of an input device or by touching a screen, but may be input by other methods such as an input of sound.

### Modifications

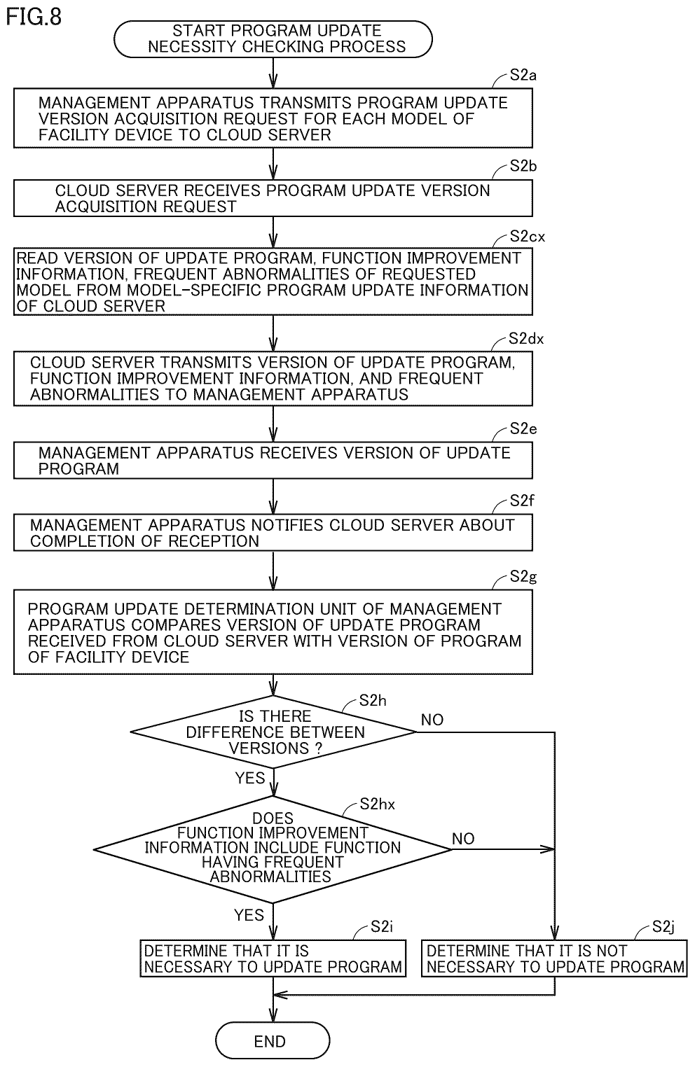

When determining whether or not it is necessary to update the control program in facility device 2, the information about the function having an abnormality in facility device 2 may be used. FIG. 8 is a flowchart showing a modification of the program update necessity checking process in FIG. 5.

Regarding a modification in FIG. 8, when management apparatus 3 transmits operation state information 45 in step S1a in the process described with reference to FIG. 4, cloud server 4 may update model-specific frequent abnormality information 93 with the use of the abnormality information included in operation state information 45. The abnormality information includes the type of abnormality and the number of occurrences of abnormalities that occur in each facility device 2. Cloud server 4 may calculate the cumulative number of occurrences of abnormality for each type of abnormality with the use of the abnormality information transmitted from management apparatus 3 (and the abnormality information transmitted from management apparatus 3 in the past). Then, cloud server 4 may update the calculated cumulative number of occurrences for each type of abnormality in facility model-specific frequent abnormality information 93. The types of the abnormality respectively relate to functions of facility devices 2.

One example of the type of abnormality is an abnormality related to the “communication” function of facility device 2 and indicated as “no destination”. “No destination” means that, when facility device 2 transmits a message to another device, an error indicating that the destination of this message does not exist has been received. Another example is an abnormality related to the “communication” function of facility device 2 and indicated as “reception of unanalyzable content”. “Reception of unanalyzable content” means that facility device 2 cannot analyze the content of a message received from another device. Still another example of the type of abnormality is an abnormality related to the “sensor cooperation” function of facility device 2 and indicated as “abnormal value acquisition”. The “abnormal value acquisition” means that facility device 2 has acquired an abnormal value from a sensor. Still another example of the type of abnormality is an abnormality related to the “sensor cooperation” function of facility device 2 and indicated as “unable to acquire sensor value”. “Unable to acquire sensor value” means that facility device 2 cannot acquire a detection value from the sensor even after a certain period of time has elapsed since facility device 2 requested the detection value from the sensor.

Among one or more types of abnormalities, cloud server 4 may store the type of abnormality that has occurred a certain number of times or more as “frequent abnormalities” in model-specific frequent abnormality information 93 separately from the above-mentioned cumulative number. Further, cloud server 4 may store the cumulative number of occurrences (and frequent abnormalities) for each type of abnormality by each model in facility model-specific frequent abnormality information 93.

The process shown in FIG. 8 includes steps S2cx and S2dx instead of steps S2c and S2d, and further includes step S2hx, in comparison with the process in FIG. 5.

In step S2cx in FIG. 8, program information management unit 83 reads the model requested in the program update version acquisition request from the version of the update program, the function improvement information, and model-specific program update information 92, and also reads the frequent abnormalities from facility model-specific frequent abnormality information 93.

In step S2dx in FIG. 8, cloud server 4 transmits the version of the update program, the function improvement information, and the frequent abnormalities about the requested model to management apparatus 3 through Internet connection management unit 82 and Internet communication management unit 110.

In step S2h in FIG. 8, when program update determination unit 33 determines that there is a difference between the two versions compared in step S2g (step S2h: Yes), it advances the control to step S2hx. In step S2hx, program update determination unit 33 reads the function improvement information transmitted from cloud server 4 in step S2dx, and specifies the function included in the function improvement information. Program update determination unit 33 also reads the abnormality information transmitted from cloud server 4 in step S2dx, and specifies the function included in the abnormality information. Then, program update determination unit 33 determines whether or not the function included in the function improvement information includes the function included in the abnormality information.

When program update determination unit 33 determines that the function included in the function improvement information includes the function included in the abnormality information (step S2hx: Yes), it advances the control to step S2i. On the other hand, when program update determination unit 33 determines that the function included in the function improvement information does not include the function included in the abnormality information (step S2hx: No), it advances the control to step S2j.

In step S2i, it is determined that it is necessary to update the program in facility device 2. On the other hand, in step S2j, it is determined that it is not necessary to update the program in facility device 2.

In the modification described above with reference to FIG. 8, it may be determined that it is not necessary to update the program even if the version of the update program downloaded from cloud server 4 is newer than the version of the control program installed in facility device 2 at the present time. More specifically, the function improvement information of the update program includes information specifying a function for which a defect has been corrected in the update program. Then, when the function improvement information of the update program does not include a function having frequent abnormalities in facility device 2 as a function for which a defect has been corrected, then, it is determined that it is not necessary to update the program in facility device 2. In other words, even if the version of the update program downloaded from cloud server 4 is newer than the version of the control program installed in facility device 2 at the present time, but if the update program does not correct the defect in the function having frequent abnormalities in facility device 2, it is determined that it is not necessary to update the program in facility device 2.

### Second Embodiment

Hereinafter, the second embodiment of the present invention will be described in detail with reference to the accompanying drawings.

### Facility Management System

A facility management system according to the second embodiment has the same configuration as that of facility management system 1 according to the first embodiment shown in FIG. 1.

### Management Apparatus

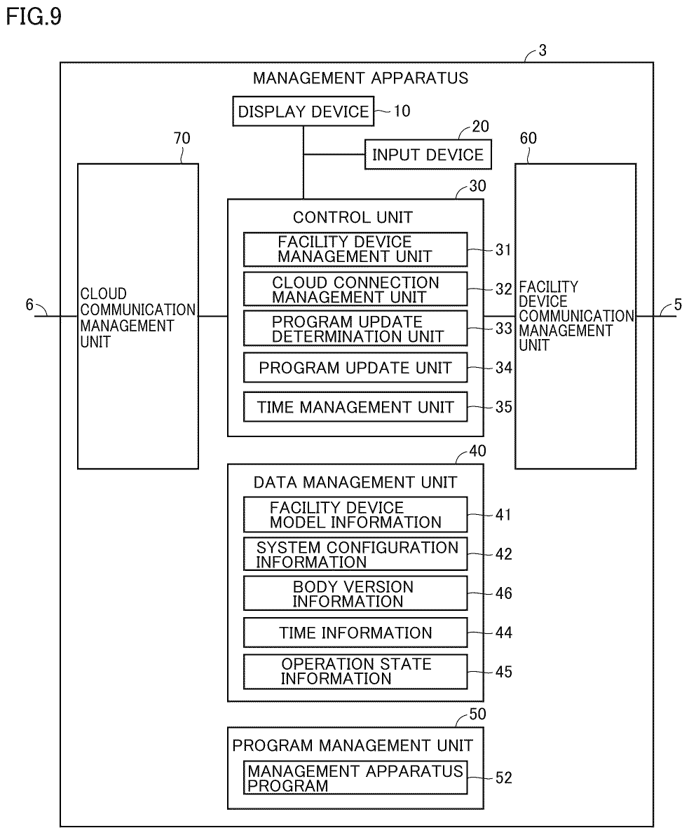

FIG. 9 is a block diagram showing a configuration of management apparatus 3 in the second embodiment. As shown in FIG. 9, in management apparatus 3 according to the second embodiment, body version information 46 is stored in data management unit 40, and a management apparatus program 52 is stored in program management unit 50, in comparison with management apparatus 3 according to the first embodiment. In the second embodiment, the update of the program in management apparatus 3 will be described. In the present specification, a program of management apparatus 3 (a program for controlling management apparatus 3) may be referred to as a “management program” or may be simply referred to as a “program”.

Body version information 46 includes program information of management apparatus 3. Specifically, body version information 46 represents information such as the version of the program of management apparatus 3 and/or the update time of the previous program in management apparatus 3.

Management apparatus program 52 includes a program of management apparatus 3 that has been downloaded from cloud server 4.

### Operation during Program Update

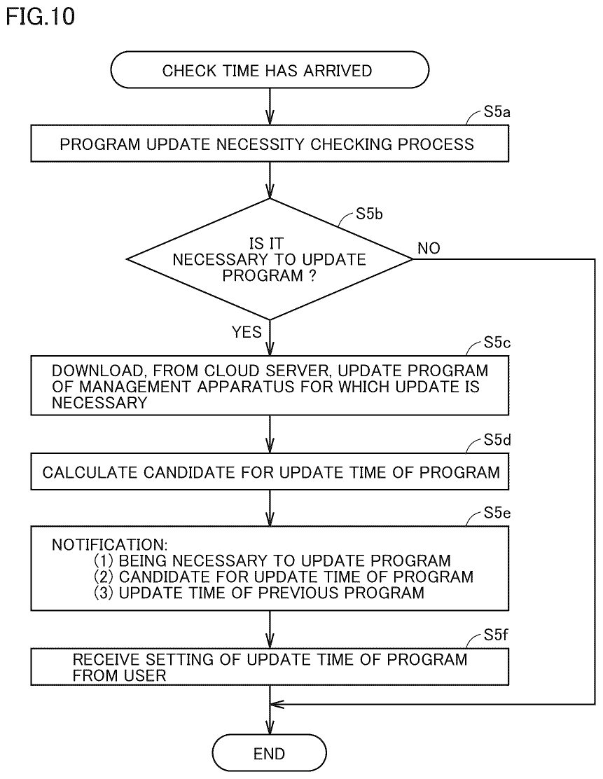

The following describes the operations of management apparatus 3 and cloud server 4 related to an update of the program in management apparatus 3 with reference to FIGS. 10 to 13.

### Update Program Check

FIG. 10 is a diagram showing a flow of an update program check process executed by management apparatus 3 and cloud server 4.

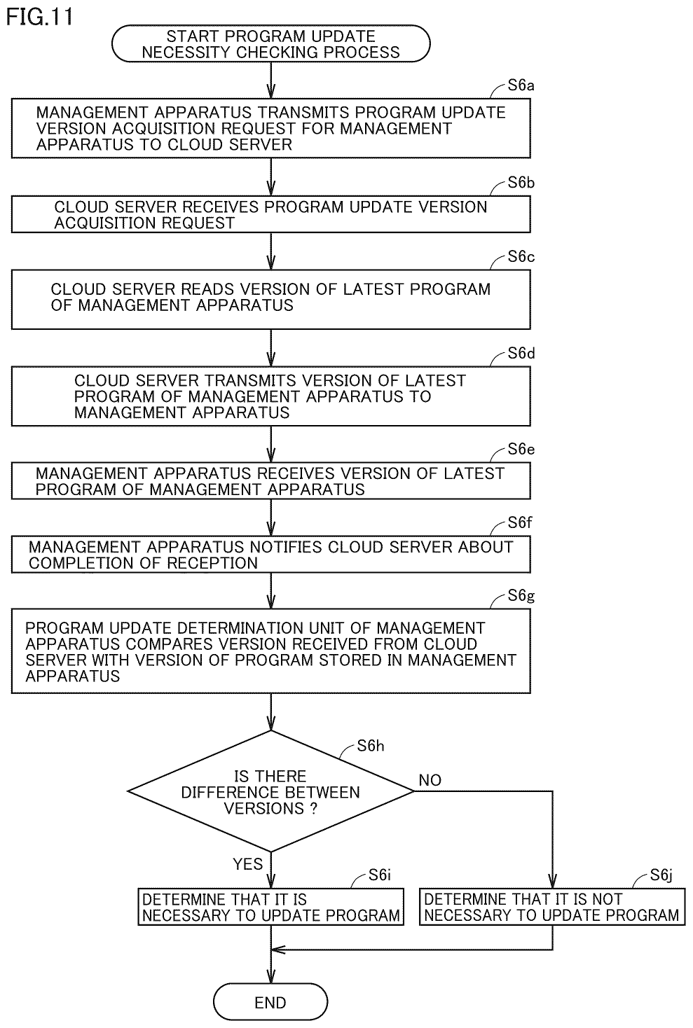

When time management unit 35 determines that the check time has arrived, cloud connection management unit 32 performs the program update necessity checking process by transmitting facility device model information 41, system configuration information 42, operation state information 45, and body version information 46 to cloud server 4 through cloud communication management unit 70 (step S5a). The details of the program update necessity checking process will be described later with reference to FIG. 11. In step S5a, the transmission of facility device model information 41, system configuration information 42, and operation state information 45 may be omitted.

The process in FIG. 10 is branched according to the result of the determination about the necessity of the program update in management apparatus 3 in the program update necessity checking process (step S5b). When it is determined that it is not necessary to update the program in management apparatus 3 (step S5b: No), program update determination unit 33 ends the process in FIG. 10.

When it is determined that it is necessary to update the program in management apparatus 3 (step S5b: Yes), management apparatus 3 downloads one or more update programs of management apparatus 3 from cloud server 4 (step S5c), and executes the following procedure. The program downloading process will be described with reference to FIG. 6.

Then, program update determination unit 33 calculates a candidate for the update time of the program from: the operation state (including an operation schedule and the like) of facility device 2 collected by facility device management unit 31; operation state information 45; or the information (including operation schedule information and the like) included in operation state information 45 (step S5d). In one implementation, in step S5d, a time zone during which all facility devices 2 are specified not to be operated or a time zone during which management of all facility devices 2 is assumed to be not necessary is set as a candidate for the update time of the program, based on the operation schedule information of each of all facility devices 2 as targets to be managed by management apparatus 3. One example of the time zone during which management is assumed to be not necessary is the same day of the week and the same time zone as those in which all facility devices 2 to be managed were stopped, in the information stored in operation state information 45 for the past one week. Other examples may be identified based on time information 44. More specifically, a time zone in which the program is scheduled to be updated for all facility devices 2 to be managed may be set as a candidate for the program update time. Still another example is a time zone in which all facility devices 2 are scheduled not to be operated, in which the time zone is specified based on the operation schedules of all facility devices 2 to be managed. Still another example is a time zone from: the time of occurrence of an environment in which (in the case of an air conditioning device, for example, the room temperature reaches a set temperature) all facility devices 2 do not need to be operated; to the closest operation start time defined in the operation schedule, in which the time zone is specified based on “various pieces of data necessary for monitoring” all facility devices 2 to be managed. When a candidate includes a certain time zone (a time zone A) and when the length of the time specified by time zone A is shorter than the length of the time assumed to be required for updating the program, time zone A may be excluded from the candidate.

Then, program update determination unit 33 notifies the user about the following three points (step S5e).
Being necessary to update a program
A candidate for update time of a program
Update time of a previous program

Subsequently, program update determination unit 33 causes display device 10 to display a setting screen for the update time of the program in management apparatus 3, and receives the setting of the update time of the program from the user (step S5f). Then, program update determination unit 33 ends the process in FIG. 10.

In the process described above with reference to FIG. 10, when a predetermined timing (check time) has arrived, management apparatus 3 determines whether or not it is necessary to update the management program for management apparatus 3. When it is determined that it is necessary to update the management program of management apparatus 3, management apparatus 3 notifies about the candidate for the update time and receives the setting of the update time from the user. Note that management apparatus 3 may set the update time without requiring the setting by the user. In one implementation, management apparatus 3 may set, as update time, the time that has been calculated as a candidate for update time without requiring an input from the user.

In the process described with reference to FIG. 10, when management apparatus 3 transmits operation state information 45 in step S5a, cloud server 4 may update model-specific frequent abnormality information 93 with the use of the abnormality information included in operation state information 45. The abnormality information includes the type of abnormality and the number of occurrences of abnormality that occur in each facility device 2. Cloud server 4 may calculate the cumulative number of occurrences for each type of abnormality with the use of the abnormality information transmitted from management apparatus 3 (and the abnormality information transmitted from management apparatus 3 in the past). Then, cloud server 4 may update the calculated cumulative number of occurrences for each type of abnormality in facility model-specific frequent abnormality information 93. Among one or more types of abnormalities, cloud server 4 may store the type of abnormality that has occurred a certain number of times or more as “frequent abnormalities” in model-specific frequent abnormality information 93 separately from the above-mentioned cumulative number. Further, cloud server 4 may store the cumulative number of occurrences (and frequent abnormalities) for each type of abnormality by each model in facility model-specific frequent abnormality information 93.

### Program Update Necessity Checking

FIG. 11 is a diagram showing a flow of a program update necessity checking process executed by management apparatus 3 and cloud server 4. When the program update necessity checking process (step S5a in FIG. 10) is started, cloud connection management unit 32 of management apparatus 3 transmits a program update version acquisition request for management apparatus 3 to cloud server 4 through cloud communication management unit 70 (step S6a).

Internet connection management unit 82 of cloud server 4 receives the program update version acquisition request (step S6b). Program information management unit 83 reads the version of the latest program of management apparatus 3 from model-specific program update information 92 (step S6c). Cloud server 4 transmits the version of the latest program of management apparatus 3 to management apparatus 3 through Internet connection management unit 82 and Internet communication management unit 110 (step S6d).

Management apparatus 3 receives the version of the latest program of management apparatus 3 (step S6e), and transmits a reception completion notification to cloud server 4 (step S6f).

Then, program update determination unit 33 compares the version received in step S6e with the version of the program stored (installed) in management apparatus 3 (step S6g).

When there is a difference between the two versions compared in step S6g, program update determination unit 33 determines that it is necessary to update the program (step S6h: Yes, and step S6i). On the other hand, when there is no difference between the two versions, program update determination unit 33 determines that it is not necessary to update the program (step S6h: No, and step S6j), and ends the process in FIG. 11.

### Download of Update Program

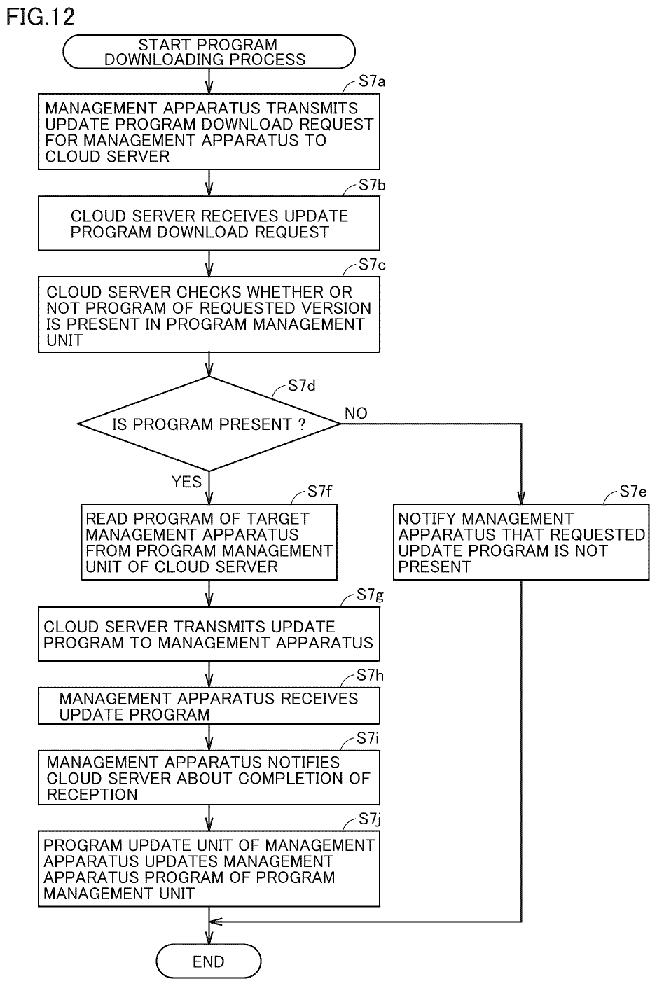

FIG. 12 is a diagram showing a flow of a program downloading process executed by management apparatus 3 and cloud server 4.

When the program downloading process (step S5c in FIG. 10) is started, cloud connection management unit 32 of management apparatus 3 transmits an update program download request for management apparatus 3 to cloud server 4 through cloud communication management unit 70 (step S7a).

Internet connection management unit 82 of cloud server 4 receives the update program download request (step S7b).

Based on model-specific program update information 92, cloud server 4 checks whether or not the requested version of management apparatus program 102 is present in program management unit 100 (step S7c).

When the requested version of management apparatus program 102 is not present in program management unit 100 (step S7d: No), cloud server 4 notifies management apparatus 3 through Internet connection management unit 82 and Internet communication management unit 110 that the requested program version is not present (step S7e), and then ends the process in FIG. 12.

When the requested version of management apparatus program 102 is present in program management unit 100 (step S7d: Yes), program information management unit 83 reads the requested version of the program (management apparatus program 102) as an update program from program management unit 100 (step S7f).

Then, cloud server 4 transmits the update program read in step S7f to management apparatus 3 through Internet connection management unit 82 and Internet communication management unit 110 (step S7g).

Upon receipt of the update program (step S7h), management apparatus 3 transmits a reception completion notification to the cloud server (step S7i).

Program update unit 34 uses the update program received in step S7h to update facility device program 51 of program management unit 50 (step S7j), and then, ends the process in FIG. 12.

### Program Update

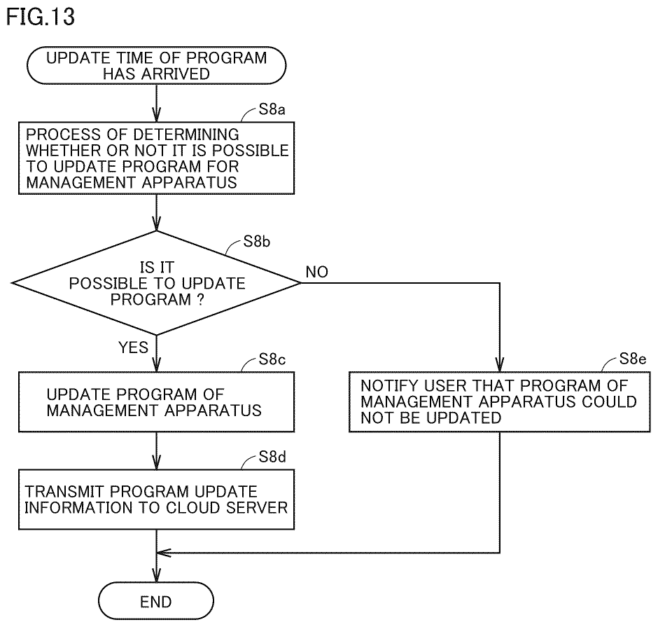

FIG. 13 is a diagram showing a flow of a program updating process executed by management apparatus 3.

When the time management unit detects that the update time of the program has arrived, program update determination unit 33 determines whether or not it is possible to update the program in management apparatus 3 (step S8a). In one implementation, program update determination unit 33 determines whether or not it is possible to update the program in management apparatus 3 based on the operation states collected by facility device management unit 31 about each of facility devices 2 to be managed. When the facility device is an air conditioning device, the operation states include, for example, an operated/stopped state, an operation mode (cooling/heating), a set temperature, an indoor temperature, and/or an operation schedule.

For example, when any of one or more facility devices 2 to be managed is in operation, or when the start time of the operation schedule of any of one or more facility devices 2 to be managed is within 5 minutes, it is determined that it is not possible to update the program. However, various standards may be provided. As an example of such standards, in a case where an air conditioning device is a management target in management apparatus 3, even when the air conditioning device is in operation, but if all of the indoor temperatures as targets to be adjusted by this currently operating air conditioning device have reached the set temperature, then, it is possible to update the program.

The process in FIG. 13 is branched according to the result of the determination in step S8a. When it is determined that it is possible to update the program in management apparatus 3 (step S8b: Yes), program update unit 34 updates the program in management apparatus 3 (step S8c). In one implementation, for updating the program, management apparatus program 52 stored in program management unit 50 is installed in management apparatus 3. Thereafter, program update unit 34 notifies cloud server 4 that the update of the program has completed (step S8d), and ends the process in FIG. 13. Thereby, in cloud server 4, the version of the updated program in management apparatus 3 is stored as management apparatus registration information 91.

When it is not possible to update the program in management apparatus 3 (step S8b: No), program update unit 34 notifies the user that the program could not be updated (step S8e), and then ends the process in FIG. 13. In step S8e, program update unit 34 may urge the user to set the update time of the program. The new update time that has been set is stored in time management unit 35. When the newly stored update time has arrived, program update unit 34 again starts the process in FIG. 13.

### Summary of the Embodiment

In the second embodiment, management apparatus 3 determines whether or not it is necessary to update the program of management apparatus 3, but management apparatus 3 does not necessarily have to make this determination. Cloud server 4 may manage the version information of the program of management apparatus 3 and determine whether or not it is necessary to update the program in management apparatus 3.

In the second embodiment, only a program that needs to be updated is downloaded. From among the programs stored in cloud server 4, management apparatus 3 may download, in advance, a program that needs to be updated and one or more programs other than the program that needs to be updated.

In the second embodiment, management apparatus 3 is configured to transmit the reception completion notification to cloud server 4 upon completion of reception, but the reception completion notification does not necessarily have to be transmitted.

In the second embodiment, the update time of the program is set by the user but does not necessarily have to be set by the user. The predetermined time may also be used as the update time of the program. The update time of the program may be set at a timing other than the check time.

In the second embodiment, the update program is downloaded from cloud server 4. However, when a program of a version scheduled to be downloaded is present in another management apparatus 3 connected through dedicated communication line 5, this program may be shared with another management apparatus 3 through dedicated communication line 5.

In the second embodiment, management apparatus program 52 stored in program management unit 50 may be only the latest program, or may be the latest program and the program before the update. The program before the update is stored in program management unit 50. Thus, when an unauthorized operation is detected after the program update, control unit 30 of management apparatus 3 installs the program before the update in management apparatus 3 and thereby can set the state of management apparatus 3 back to the state before the update.

In the first embodiment, the update of the program in facility device 2 has been described. In the second embodiment, the update of the program in management apparatus 3 has been described. Note that management apparatus 3 may be configured to be capable of simultaneously updating the programs of both management apparatus 3 and facility device 2. In one implementation, when the check time arrives, management apparatus 3 starts the processes in FIGS. 4 and 10 in parallel.

According to facility management system 1 in the second embodiment, management apparatus 3 automatically acquires the program update information of management apparatus 3 from cloud server 4. This eliminates the need for the user to periodically check the update information. Further, management apparatus 3 determines whether or not it is necessary to update the program, and then, updates the program of this management apparatus 3 at an appropriate timing. Thereby, the latest program can always be applied to management apparatus 3 without having to request service from a service company.

According to facility management system 1 in the second embodiment, the user can be notified that it is necessary to update the program of management apparatus 3. This makes it possible to avoid a situation in which the user continues to use management apparatus 3 without knowing the presence of the update program of management apparatus 3.

According to facility management system 1 in the second embodiment, it is possible to update the program in management apparatus 3 at a timing at which the user's comfortability is not impaired.

According to facility management system 1 in the second embodiment, when updating the program in management apparatus 3, it is not necessary for a user (a worker) to visit the site, so that the load applied when updating the program can be reduced.

According to facility management system 1 in the second embodiment, candidates for the program update time are presented, so that the load applied to the user when determining the program update time in management apparatus 3 can be reduced.

According to facility management system 1 in the second embodiment, the update timing of the program in management apparatus 3 is set based on the operation schedule of facility device 2, and thus, the countermeasures against the defective operation of facility device 2 can be taken more reliably even in an environment in which the operation of facility device 2 cannot be easily stopped. In other words, the latest program can always be installed in management apparatus 3, which makes it possible to more reliably prevent the function of facility device 2 from being stopped (due to the older program in management apparatus 3).

It should be understood that the embodiments disclosed herein are illustrative and non-restrictive in every respect. The scope of the present disclosure is defined by the scope of the claims, rather than the description of the embodiments provided above, and is intended to include any modifications within the meaning and scope equivalent to the scope of the claims.

### REFERENCE SIGNS LIST

1 facility management system, 2 facility device, 3 management apparatus, 4 cloud server.

1. (canceled)

2. A management apparatus that manages one or more facility devices constituting a facility device group, the management apparatus comprising:
a storage device to store a version of a control program stored in each of the one or more facility devices;
a communication interface to communicate with a server storing a control program of the facility device; and
a controller to, in response to arrival of a predetermined timing, for each of the one or more facility devices, determine whether or not it is necessary to update the control program, by comparing the version of the control program stored in the storage device with a version specified by version information of the control program stored in the server, wherein
the controller is configured to download the control program for a facility device for which it has been determined that it is necessary to update the control program wherein
the controller is configured to determine whether or not it is necessary to update the control program by comparing, for each model of the facility device, the version of the control program stored in the storage device with the version specified by the version information of the control program stored in the server.

3. A management apparatus that manages one or more facility devices constituting a facility device group, the management apparatus comprising:
a storage device to store a version of a control program stored in each of the one or more facility devices;
a communication interface to communicate with a server storing a control program of the facility device; and
a controller to, in response to arrival of a predetermined timing, for each of the one or more facility devices, determine whether or not it is necessary to update the control program, by comparing the version of the control program stored in the storage device with a version specified by version information of the control program stored in the server, wherein
the controller is configured to download the control program for a facility device for which it has been determined that it is necessary to update the control program, wherein
the controller is configured to determine whether or not it is necessary to update the control program by determining, for each model of the facility device, whether or not function improvement information of the control program stored in the server is suitable for a program update setting that is set in advance.

4. The management apparatus according to claim 2, wherein, for a facility device for which it has been determined that it is necessary to update the control program, the controller is configured to notify about necessity of an update by at least one of a display on a display device and a notice given to a user of the facility device.

5. The management apparatus according to claim 4, wherein, for a facility device for which it has been determined that it is necessary to update the control program, the controller is further configured to notify about a candidate for update time of the control program.

6. The management apparatus according to claim 5, wherein, for each facility device for which it has been determined that it is necessary to update the control program, the controller is configured to calculate the candidate based on an operation schedule of each facility device.

7. The management apparatus according to claim 2, wherein, for each facility device for which it has been determined that it is necessary to update the control program, the controller is configured to determine whether or not to update the control program based on an operation state of each facility device.

8. The management apparatus according to claim 2, wherein
the storage device is configured to store a management program for controlling the management apparatus, and
the controller is configured to:
in response to arrival of the predetermined timing, determine whether or not it is necessary to update the management program in the management apparatus, by comparing a version of the management program stored in the storage device with a version specified by version information of a management program stored in the server, and
when it is determined that it is necessary to update the management program in the management apparatus, download the management program of the management apparatus from the server.

9. The management apparatus according to claim 8, wherein the controller is configured to calculate a candidate for update time of the management program based on an operation schedule of each of the one or more facility devices.

10. The management apparatus according to claim 8, wherein the controller is configured to determine whether or not to update the management program based on an operation state of each of the one or more facility devices.

11. The management apparatus according to claim 2, wherein, for a facility device for which it has been determined that it is necessary to update the control program, the controller is configured to download a control program from an information processing apparatus other than the server.

12. The management apparatus according to claim 5, wherein the candidate represents update start time or a time zone that is able to be designated as the update start time.

13. The management apparatus according to claim 2, wherein the controller is configured to determine whether or not it is necessary to update the control program, by further comparing a type of a function having frequent abnormalities in the one or more facility devices with a type of a function for which a defect has been corrected in the control program stored in the server.

14. A method of managing one or more facility devices by a management apparatus, the one or more facility devices constituting a facility device group, the method comprising:
in response to arrival of a predetermined timing, for each of the one or more facility devices, determining whether or not it is necessary to update a control program, by comparing a version of a control program stored in a storage device of the management apparatus with a version specified by version information of a control program stored in a server; and
for a facility device for which it has been determined that it is necessary to update the control program, downloading the control program from the server, wherein
the storage device is configured to store a management program for controlling the management apparatus, and
the method further comprises:
in response to arrival of the predetermined timing, determining whether or not it is necessary to update the management program in the management apparatus, by comparing a version of the management program stored in the storage device with a version specified by version information of a management program stored in the server;
when it is determined that it is necessary to update the management program in the management apparatus, downloading the management program of the management apparatus from the server; and
determining whether or not to update the management program based on an operation state of each of the one or more facility devices.
